(19) United States
(12) Patent Application Publication
(10) Pub. No.: US 2006/0085252 A1
(43) Pub. Date: Apr. 20, 2006

(54) Incentive program

(76) Inventor: Robert D. Kersenbrock, Lake Mary, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/967,409

(22) Filed: Oct. 18, 2004

(51) Int. Cl. G06Q 30/00

(52) U.S. Cl. 705/14

(57) ABSTRACT

An incentive program is described that rewards the participants of the program based on the actions of at least something other than the participants. An incentive program coordinator that can be an individual, a legally created entity, or other organization can run the incentive program. The incentive program coordinator can have business relations with the participating entities, a sponsor, other business entities, or some combination thereof. The participating entities can be individuals, legally created entities, or other organizations, as can the sponsor entity. The at least something other than the participants can be a sports team in one embodiment.

### TECHNICAL FIELD

The present invention relates to business methods particularly, but not exclusively, to business structures and methods that reward a participant in an incentive program based on the performance of at least something other than the participant.

### BACKGROUND

Incentive programs are well known. Common examples of incentive programs are frequent flyer miles programs or credit cards that give a program participant rewards based on every purchase made by the participant using the card. These incentive programs seek to attract new customers or participants in the incentive program by offering them rewards in exchange for actions that they take. For example, in a typical frequent flyer miles program, the participant obtains miles for each plane ticket that they purchase from a particular airline. If the participant purchases a significant number of airline tickets, for example in excess of $5,000 worth of airline tickets in a year, the participant gets a certain amount of free airplane tickets as a reward. The purpose of such programs is that once the participant begins the program they are less likely to switch airlines because of their vested interest in the amount of rewards that they have already earned. Plus, the participant obtains rewards for what they already perceive as expenses that they will have to pay. Therefore, the airline increases its market share and loyal customer base. Of course, this type of incentive program is simply illustrative and there are many different types of incentive programs that exist.

As another example, incentive programs that use additional parties are also known. For example, a credit card company may form a partnership with a gasoline company in order to increase the sales for both companies. They do so by creating an incentive program. The incentive program is commonly structured such that every time the participant purchases gasoline from the gasoline company using a credit card offered by the credit card company, they gain credits toward future purchases of gasoline. Thus, a participant who consumes a lot of gasoline over the course of time or prefers one brand of gasoline over others would be motivated to obtain such a credit card. Once the participant is obtained, additional credit card transactions are made. As a result, the merchant who offers the gasoline must pay additional credit card fees thereby improving the revenue of the credit card company. Plus, the gasoline company wins because the participant purchases gasoline under their brand and not their competitor's brands. The participant is incented to use the credit card so that they gain the benefit of the credits that they earn through purchasing gasoline with the card over time. Finally, the participant is happy because the gas that they already had to buy is now a little bit cheaper because of the credits they earned based on the purchases that they made. Therefore, this is an incentive program having a structure of three parties: a sponsor (the gasoline company), a credit card issuer (the company that provides the credit card) and a participant (the consumer who purchases gasoline).

Yet another form of an incentive program is an employer/employee program designed to increase the sales of its employees. The employees participate in the incentive program that is coordinated by an incentive program coordinator. Upon certain types of activities by the employees, rewards are earned. For example, if the employees hit a certain level of sales, then the incentive program coordinator offers free vacations to various locations. The employer pays the incentive program coordinator a fee for offering these services and in return the employer hopes the incentive program improves the sales of the employer by stimulating the employees.

Incentive programs are therefore operated in a variety of ways. They can include multiple participants, multiple incentive program operators, currency card issuers, employers, or a variety of other structures and methods of doing business. Heretofore, all of the incentive programs, however, have all based the rewards provided to the participant based on the participant's own actions. For example, the amount of money the participant spends on airplane tickets determines how many miles they receive. In the credit card example, the amount of gas purchased from the certain gasoline company, the number of credit card uses or the amount of money spent by the participant determines the amount of rewards provided. Similarly, the amount of sales or other actions by the employees determines the amount of incentives that they receive.

Therefore, needs remain in this area.

### SUMMARY

One aspect of the invention includes a method for influencing the behavior of a participant in an incentive program comprising rewarding the incentive program participant based on the performance of at least something other than the incentive program participant.

Another aspect of the invention includes a method for influencing the behavior of a participant in an incentive program run by a program coordinator comprising entering the participant into the incentive program; operating the incentive program with the program coordinator; and rewarding the participant based on the performance of at least something other than the incentive program participant.

A further aspect of the invention includes a method for allowing a program coordinator to suggest desired behavior in a participant comprising entering the participant into an incentive program; and rewarding the participant based on the performance of an unrelated third party.

Another aspect of the invention includes a method to provide incentives to consumers comprising enrolling the consumer into an incentive program; providing an incentive program membership identifier to the consumer; and rewarding the consumer based on the performance of at least something other than the consumer.

Yet a further aspect of the invention includes a method for influencing the behavior of a participant in an incentive program operated by a program coordinator comprising requesting qualifying information from a potential participant; determining if the potential participant qualifies to be a participant in the incentive program; enrolling the potential participant into the incentive program to become the participant; rewarding the participant based on the actions of at least something other than the participant; determining periodically if the participant has maintained eligibility to remain in the incentive program; and terminating the participants enrollment in the incentive program if eligibility is lost.

Another aspect of the invention includes a business structure comprising a currency card issuing entity; an incentive program coordinator entity operatively coupled to the currency card legal entity, wherein the incentive program coordinator calculates and issues rewards; a participant entity operatively coupled to the currency card issuing legal entity, wherein the coupling results in the participant entity possessing a currency card; and at least something other than the participant entity, wherein the actions of the at least something other than the participant entity determines the amount of rewards provided by the incentive program coordinator to the currency card issuer that are redeemable by the participant entity.

Another aspect of the invention includes a business structure to operate an incentive program comprising a sponsor entity; an incentive program coordinator entity operatively coupled to the sponsor entity; and a participant entity operatively coupled to the incentive program coordinator entity in the incentive program determined by the sponsor entity, wherein the incentive program coordinator rewards the participant entity based on the actions of at least something other than the participant entity.

Yet another aspect of the invention includes a method to reward consumers based on increased currency card transactions comprising providing the currency card to the consumer; providing the rewards to the consumer based on the performance of at least something other than the consumer; and requiring the consumer use the currency card a minimum number of times during a predetermined period to obtain the rewards earned by the at least something other than the consumer.

A further aspect of the invention includes a method for influencing the behavior of a participant in an incentive program operated by a program coordinator comprising enrolling a participant into an incentive program; requiring the participant to satisfy criteria to qualify to receive rewards; and rewarding the participant based on the actions of at least something other than the participant after the participant satisfies the criteria.

### BRIEF DESCRIPTION OF THE DRAWINGS

FIG. 1 illustrates a schematic block diagram of one embodiment of the present invention.

FIG. 2 illustrates a schematic block diagram of an alternate embodiment.

FIG. 3 illustrates a schematic block diagram of yet another alternate embodiment.

FIG. 4 illustrates a schematic block diagram of a further alternate embodiment.

FIG. 5 illustrates a schematic business structure diagram according to one embodiment.

FIG. 6 illustrates an alternate schematic business structure diagram according to another embodiment.

### DETAILED DESCRIPTION OF THE SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations, modifications, and further applications of the principles of the present invention as illustrated are contemplated as would normally occur to one skilled in the art to which the invention relates.

Specific examples of the principles of the invention in application will be described in the next two following examples. It is to be understood, however, that no limitation of the invention is intended by the description of these two specific examples. The claims define the present invention and the following examples are not to be used to alter the scope of the invention described in the claims. After these few specific examples are described, a more broad description of different embodiments that are contemplated by the present invention is provided along with corresponding drawings thereto. Even these broader descriptions are not intended to alter the scope of the invention defined by the claims.

One specific example of the invention is an incentive program that rewards participants based on the performance of their favorite sports team. The participant is an individual who lives in St. Louis and loves football. The participant obtains a credit card from a bank, like Citibank®, and enters an incentive program that is available for eligible customers of the bank. The individual is eligible because he is carrying a balance on the card, has no late payments, and has used the card at least five times over the past month. The incentive program provides incentives to the individual card holder based on the performance of a third party sports team. The participant chooses the St. Louis Rams and is rewarded every time the St. Louis Rams wins a game, scores a touchdown, scores a field goal, etc. The rewards are points on the participants credit card. For an illustration of how points can be awarded reference to U.S. Pat. No. 5,025,372 is suggested.

The second example concerns an individual who lives in Cincinnati and loves baseball. The individual receives a credit card from Citibank®. The individual is eligible to enroll in an alternate incentive program because the card has a balance, no payments are late, and the individual has used the card five times over the past month. This alternate incentive program bases the rewards on the performances of individual athletes in a given sports category. This is similar to the structure used in sports fantasy leagues. The individual chooses Ken Griffey Jr. of the Cincinnati Reds. The program awards points, like those in the 5,025,372 patent, to the individual based on the performance of Ken Griffey Jr. Thus, if Ken Griffey Jr. has two homeruns, four hits, and one steal in one night and a homerun is worth 10 points, a hit 2 points, and a steal 5 points then the individual earns 33 points based on Ken Griffey Jr.'s performance.

Generally speaking, an incentive program is described that rewards the participants of the program based on the actions of at least something other than the participants. An incentive program coordinator that can be an individual, a legally created entity, or other organization can run the incentive program. The incentive program coordinator can have business relations with the participating entities. The participating entities can be individuals, legally created entities, or other organizations. The incentive program coordinator can also have business relations with a sponsor or another business entity. The participants of the incentive program receive rewards based on the performance of at least something other than the participants. For example, the participants in one embodiment could receive rewards based on the actions of a favorite sports team. If the sports team performs well, the participant gets more rewards. Therefore, the participant obtains rewards regardless of whether their own performance or actions are desirable. In other embodiments, the participant also influences the amount of rewards received along with the performance of something other than the participant.

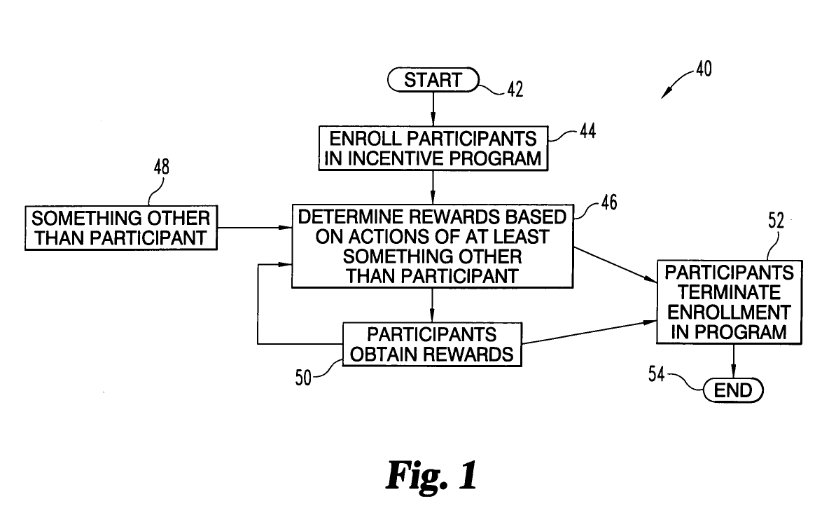

Referring now to the drawings, FIG. 1 illustrates an incentive program 40 according to one embodiment of the present invention. The incentive program 40 is illustrated as a process in a schematic form with a start block 42 and an end block 54. First, an entity is enrolled into an incentive program at block 44 thereby becoming a participant in the incentive program. In block 46, the amount of rewards to be given to the participant based on actions by at least something other than the participant is determined. The term “at least something other than the participant” is intended to be anything besides solely the participant itself. For example, an unrelated third party, such as a sports team or company, could have their performance evaluated to determine if rewards are given to the participant. The sports teams could be at a professional, high school, college, or any other level. Moreover, other examples include, but are not limited to, famous athletes, a country, a race horse, or a race car. If the participant is a racetrack fan, rewards based upon the race horse performance would be desirable to the participant or if the participant is an investor, rewards based upon stock market performance would be desirable to the participant. Alternatively, “at least something other than the participant” could be another participant in the incentive program. Moreover, a combination of the participants actions and “at least something other than the participant,” could determine the rewards.

The amount of rewards to be provided to the participant in block 46 is determined by receiving input from at least something other than the participant 48. If the amount of rewards to be given were based on sports team performances, the performance of the relevant sports team(s) would be provided to block 46. For example, if the rewards were based on a professional football team score, the score would determine the amount of rewards provided. Alternatively, if at least something other than the participant was the performance of a stock, the amount of dollars that the stock went up over the course of a certain period could be used to determine the amount of rewards provided. In another embodiment, if a country was the “at least something other than the participant,” then the strength of the currency compared to other currencies could determine the amount of rewards. In another embodiment, the amount of times a horse wins races over the course of a certain period could determine the amount of rewards. Other types of actions of things other than the participant that are readily apparent to those skilled in the art in view of the present disclosure are also contemplated.

The information concerning the performance of at least something other than the participant can be obtained by any method readily apparent to those skilled in the art. For example, databases run by companies such as ESPN or other sports related entities could be utilized in order to determine the amount of points to be awarded. The determining of the points to be awarded could also be performed by an incentive program coordinator. The incentive program coordinator could be an entity such as an individual or a corporation. The individual or corporation could use a computer method or any other method readily apparent to those skilled in the art to obtain and process the information concerning the performance of at least something other than the participant.

Next, the participants can either obtain the rewards as shown in block 50 or terminate the enrollment in the program as shown in block 52. The participants can obtain the rewards in a variety of different manners. In some embodiments, the participants obtain the rewards by receiving points, miles, credits, or any other quantum of value that could be accessed by a credit card. In other embodiments, the rewards are provided by simply sending cash in the form of a check or money order directly to the participant. In some other alternate embodiments, the rewards can be tickets to a sporting event or discounts on food served at the sporting event. In other embodiments, the rewards are the ability to meet one of the famous players of a favorite sports team of the participant. In further embodiments, the rewards are coupons that are redeemable at selected merchants. In further embodiments, the rewards are gift certificates that could be realized at a number of merchants or providers of entertainment, travel rewards, or merchandise that can be ordered or obtained through any medium. In some other embodiments, the rewards could be the granting of an option to buy a stock or a mutual fund at a certain lower-than-market price. Alternatively, the rewards could be the reduction in the amount of points or fees charged by a mutual fund company to invest in their funds. As one skilled in the art would readily recognize, there are infinite types of rewards that could be provided to the participant in the incentive program.

As block 52 illustrates, participants can terminate enrollment in the program. This termination of enrollment in the incentive program could either be voluntary or involuntary. For example, in an incentive program where a credit card is used, enrollment might be involuntarily terminated by the program coordinator if the credit card user fails to use the credit card a minimum number of times per a designated time period. Alternatively, the participant may voluntarily decide to leave the incentive program. Therefore, the participant may lose all of the credits earned for them by the third party actions, or the combination of their actions and the third party actions, or in some embodiments the credits gained could be converted to a transferable amount of value. In addition, the participant may simply decide to switch to a different incentive program coordinator that allows the transfer of the quantum of value earned between programs. Also, the participant simply can terminate their involvement to choose a different third party whom they believe will have more success in earning rewards for the participant. Once the entity is no longer participating in the incentive program 40, the incentive program 40 for that participant comes to an end as represented by block 54.

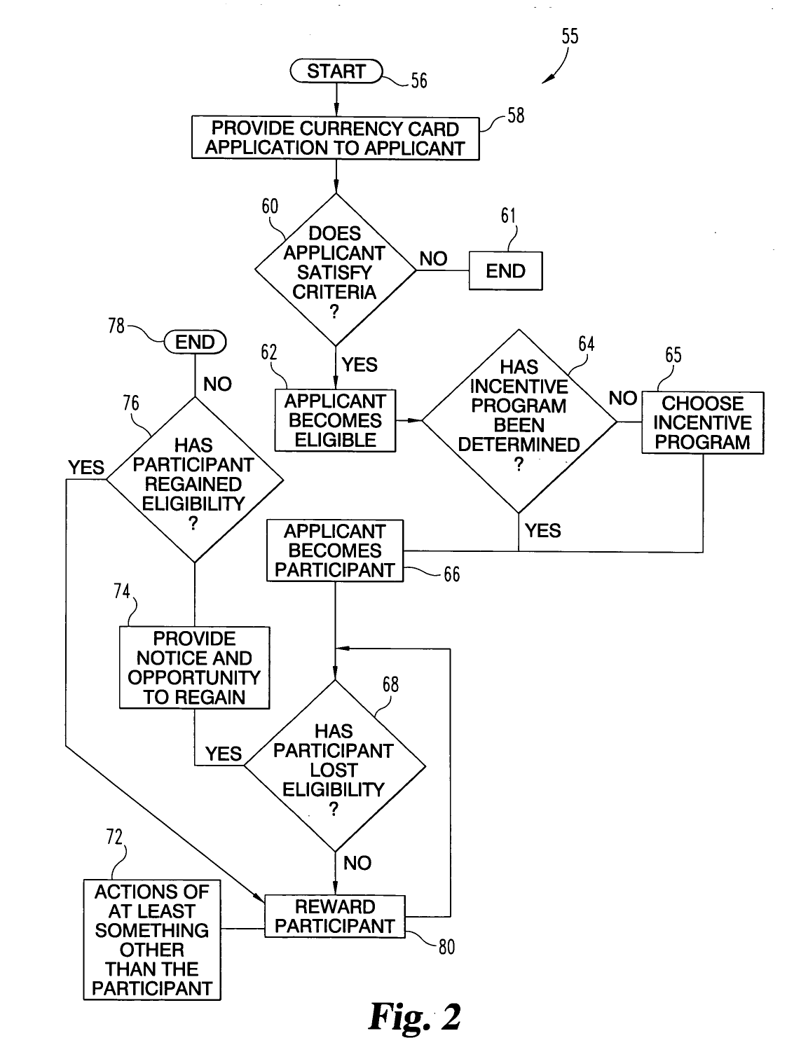

An alternate embodiment is illustrated in FIG. 2. The alternate embodiment is also illustrated as a process in schematic form. In this embodiment, the process 55 begins at the start block 56. The first step is to make a currency card application available to an applicant, as shown in block 58. The next step, shown in decision tree 60, determines if the applicant satisfies criteria for enrollment into the incentive program. If the applicant does not satisfy the criteria, the process ends at block 61. If the applicant does satisfy the criteria, however, the applicant becomes eligible to enroll in a selected incentive program or programs, as illustrated in block 62. Whether applicant is participating in an incentive program is determined next, as shown in decision tree 64. If the applicant has previously elected to participate in an incentive program, then the algorithm moves to block 66. If the applicant has not previously elected to participate in an incentive program, then they get the ability to choose the incentive program they would like to participate in, as shown in block 65. At block 66 the applicant then becomes a participant in the incentive program and in some embodiments an incentive program membership identifier is provided to the participant. The incentive program membership identifier can be a currency card, an account number, an electronic signature, computer password, and/or other identifier readily apparent to those skilled in the art. Then the eligibility to participate in the program is checked in block 68. If the participant has not lost eligibility, then the participant gets rewarded, shown at block 70, based on the actions of at least something other than the participant, shown in block 72. If the participant has lost eligibility, then notice and opportunity to regain eligibility is provided to the participant, as shown in block 74. If the participant has regained eligibility, as determined at decision tree 76, then the participant is rewarded in block 70. If the participant hasn't regained eligibility after providing notice and opportunity to regain eligibility the process ends at block 78.

Referring to block 58, a currency card as used in this application means any type of card that can be used to perform monetary transactions. For example, a credit card, a debit card, a check card, or other type of card that can use currency as a medium of transfer is contemplated. The application for a currency card can be made available to applicant in a variety of ways. For example, the applicant can seek an application to join an incentive program at a card issuer's web site, address, or by calling the card issuer. Alternatively, mailings of applications for credit cards or debit cards can be provided to participants at their home. In addition, corporations can be contacted at their place of business to provide an application for a currency card. Also, the application could simply be for entering into the incentive program. For example, an already established cardholder could add the incentive program as an additional benefit to their existing cardholder agreement with the credit card company, or enrollment in the incentive program could result in the automatic issuing of a currency card to the new participant. In addition, the applications could be offered directly, such as at college campuses or other forms of direct marketing. Therefore, any possible way readily apparent to those skilled in the art of providing the materials to an applicant are contemplated.

At decision tree 60, the applicant is scrutinized to determine if they satisfy the criteria necessary to be eligible in an incentive program. Alternatively, eligibility can also be automatically provided, in some embodiments, thereby starting the process at decision tree 64. For example, a currency card issuer provides a credit card to a large number of participants who already qualify.

If eligibility is to be determined, the determination can be performed in various ways. For example, the fiscal strength of the applicant can be scrutinized, in some embodiments. This can be done by doing credit checks, requesting verification of income or other funds, or by any other method readily apparent to those skilled in the art.

In some alternate embodiments, the analyzed criteria are demographic information about the applicant. For example, in one embodiment the something other than the participant is the Democratic Party and the participant is a staunch Democratic Party supporter. Determining the political affiliation of the participant may be necessary to enter the applicant into the incentive program that rewards the participant based on the performance of the Democratic Party. Alternatively, if the applicant is a younger individual, the performance of something other than the participant could be the record sales of their favorite music artist, thus, determining the applicant's favorite artist would be necessary.

In some other embodiments, the criteria analyzed could be the purchasing patterns of the applicant. For example, if the applicant was an already existing customer, information about where applicant shops could be determined and the applicant could be entered into an incentive program corresponding thereto. For example, suppose the purchasing records of the applicant shows that they shop at Lowe's® every time home improvement materials are needed. If the incentive program rewards were credits that could be applied at Home Depot® the applicant may not meet the criteria to participate in (i.e. would not be interested in) an incentive program that rewards by providing Home Depot® credits. Other analyzing of criteria can use a combination of some or all of the above mentioned indicators. Furthermore, other types of eligibility information readily apparent to those skilled in the art are also contemplated.

At block 62 when the applicant becomes eligible, the applicant may or may not have determined an incentive program in which to enroll (as determined by decision tree 64). The type of incentive program, if not already chosen, is determined at block 65. In some embodiments, the applicant can choose the incentive program in which they would like to participate. In some of these embodiments, the applicant can choose to participate in more than one incentive program or can switch incentive programs during their period of participation. Alternatively, the incentive program can be predetermined for an applicant. For example, perhaps the currency card issuer would provide an application for the professional football team of that applicant's metropolitan area. If the applicant decides to fill out the application and they qualify, then they are enrolled into the incentive program where the amount of rewards is provided based on the performance of that specific professional football team. Alternatively, as shown in block 65, in some embodiments the applicant can choose their own incentive program. For example, if the applicant's favorite football team is located in another state, they may choose that favorite football team. It is contemplated by the present invention that the applicant can even chose aspects of the incentive program, such as which players of their professional football team performances will determine their rewards.

Once the applicant becomes a participant at block 66, it is necessary to determine if the participant has lost eligibility at decision tree 68. In some embodiments, the participant cannot lose eligibility. Once the participant has started participating in the program, they are participating in the program until the program itself comes to an end or the participant withdraws from the program. In other embodiments, however, the participant can lose eligibility. For example, in one embodiment, in order to stay in the program, the participant must use their currency card a certain amount of times over a certain time period. To illustrate, if the currency cardholder uses the currency card five times in a month, then the currency card owner remains eligible to stay in the incentive program. However, if they use their card less than five times per month, then they lose the right to participate in the incentive program (at least for that month). Similarly, a program based on the amount of expenditures is contemplated. In addition, in some other embodiments the participant could lose eligibility by failing to make a payment on their currency card or by having a late payment during the month.

Moreover, in other embodiments, the participants can enter themselves into an earning status by satisfying certain criteria. In other words, the participant, while enrolled, has not gained the ability to obtain rewards until they satisfy certain criteria. For example, the participant must use their card at least three times a month before they are eligible to receive points in some embodiments. In other embodiments, the participant needs to dine from a selected group of restaurants a certain number of times a month. Those skilled in the art will recognize that there are an infinite number of factors that can be used to determine if a participant has obtained an earning status.

In some embodiments, upon the loss of eligibility, the participant loses all of the rewards earned for them by something other than the participant. In other embodiments, the participant can “cash out” their rewards at the end of their participation. In other embodiments, eligibility is only suspended for the month during which the participant failed to satisfy the requirements for eligibility. In addition, in the illustrated embodiment, in block 74 the participant is provided notice of the fact that they have lost or are about to lose their eligibility and provided an opportunity to reestablish eligibility. For example, if the participant has to use the credit card at least five times in a month and the participant fails to do so, the participant is notified of such failure and is given the opportunity to begin using the card once again five times a month. Alternatively, the participant may have to use the card at a higher frequency to regain eligibility, for example six times per month.

The notice could be provided in any manner readily apparent to those skilled in the art. For example, notice could be provided in the credit card statement bills sent monthly. Alternatively, the e-mail address of the participant could be obtained and an e-mail notification sent to their e-mail address. In some embodiments, the notification could be separate from the credit card statement. In other embodiments, the notice is provided by a telephone call. After the participant has given notice and an opportunity to regain eligibility, eligibility is checked again at decision tree 76. Eligibility could be regained by any manner apparent to those skilled in the art. As shown in block 70, the participant is then rewarded based on at least something other than the participant. This can continue indefinitely. It is noted, once again, that the rewards can be determined from a plethora of options. Cash, checks, points, tickets to a sports team, discounts on food at an event, gift certificates, coupons, plane tickets, commodities, stocks, travel rewards, merchandise that can be ordered or obtained through any medium, or any other reward readily apparent to those skilled in the art are contemplated.

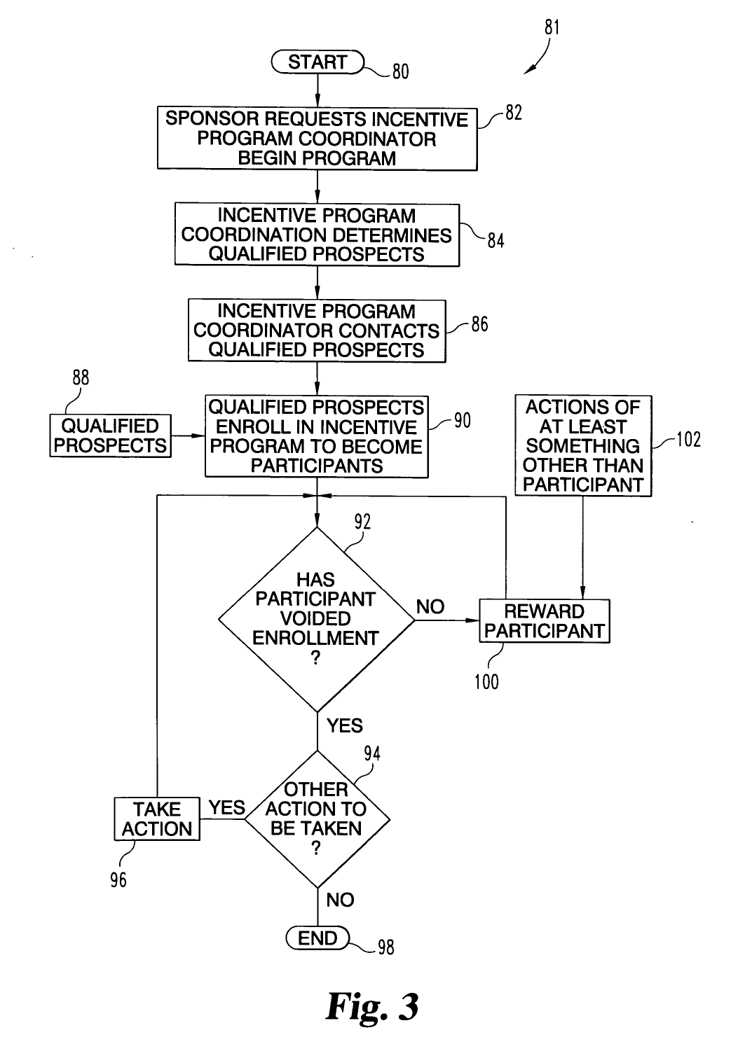

Referring now to FIG. 3, an alternate embodiment as illustrated. As in FIGS. 1 and 2, the embodiment illustrated in FIG. 3 is a process 81. The process begins at start block 80 and moves to block 82. At block 82, a sponsor requests that an incentive program coordinator begin an incentive program. Next, in block 84, the incentive program coordinator determines qualified prospects. Once the incentive program coordinator determines the qualified prospects, they then contact the qualified prospects as shown in block 86. Upon being contacted by the incentive program coordinator, the qualified prospects, as shown in block 88, can enroll in an incentive program and become a participant as shown in block 90. Once the participants are established, then at decision tree 92 it is determined whether or not the participants have voided their enrollment. If the participant had voided enrollment, the algorithm then moves next to decision tree 94 to determine if there is any action that needs to be taken. If there is action to be taken, then the action is taken at block 96. If there is no other action to be taken, then the algorithm ends at block 98.

If the participant has maintained enrollment in the incentive program, then the participant is rewarded at block 100 based on the actions of at least something other than the participant 102. Once the participant is rewarded, the process returns to determining if they have voided enrollment 92. If they haven't voided enrollment, then the participant continues to be rewarded until enrollment is voided. In some embodiments, enrollment can be voided simply by the passing of time. It is contemplated, however, that the participant will continue to be rewarded based on the non-participant actions until the year of enrollment has finished, in some embodiments. The participant can be rewarded in a variety of manners like those discussed with respect to the embodiments illustrated in FIGS. 1 and 2.

Referring to block 82, the sponsor could be any entity desiring to start an incentive program. For example, the sponsor could be a sports team, a mutual fund company, a corporation, or an individual. The sponsor wants to create an incentive program in order to create a buzz about their product or services. In addition, the sponsor may be attempting to increase the number of customers of their product or service or may be attempting to do test marketing or other types of business activities. The incentive program coordinator can be an organization, individual, or any other entity readily apparent to those skilled in the art. The incentive program coordinator may contact the participants directly or use an alternate company to help locate the participants. The incentive program coordinator also sets up the boundaries, regulations, rules, and other aspects of the incentive program.

Referring to block 84, the qualified prospects can be determined from a variety of factors. Demographic data, financial strength data such as credit scores and analysis of net worth and purchasing patterns are all types of information that could be used in some embodiments in determining a qualified prospect. The incentive program coordinator may already be in possession of this type of information, there may be other entities who have this information, or they can obtain it in any other method readily apparent to those skilled in the art. Qualified prospects are used in this embodiment because the sponsor is paying a fee in order to obtain a desired result. In the other embodiments, the contacting of participants can be random since anyone may be the intended participant. Conversely, in the present embodiment, the sponsor likely desires to attract a certain group that they are attempting to reach. For example, if the sponsor were a sports team, they likely would only be interested in contacting fans of the sport. If the sponsor were an investment company, they likely would only want to contact people who would be interested in investing or have the money to do so. Contacting the qualified prospects can be done in any manner readily apparent to those skilled in the art.

Block 92 determines whether the participant has voided enrollment. The participant could void the enrollment based upon the rules that were put together by the incentive program coordinator. If the rules require that a certain amount of money be spent over a certain period of time and the participant had not done so, then they may have voided their enrollment. Alternatively, if the participant was required to attend a certain number of sports games in a year in order to qualify for the incentive program, failing to attend those games could void them. It would be readily apparent to those skilled in the art that an infinite amount of situations could be imagined that could result in the voiding of enrollment.

At block 94, whether or not action needs to be taken is determined. For example, in some embodiments, the incentive program coordinator attempts to contact the participants. This could be in the form of contacting the participant and informing them that they are soon to lose their eligibility to participate in the incentive program and that could result in a loss of the rewards or credits obtained until that point of time. In other embodiments, as soon as the eligibility is voided that means the participant is no longer participating in the incentive program and there is no ability for the participant to change their status. Different embodiments have different types of action to be taken or can even decide to take no action at all.

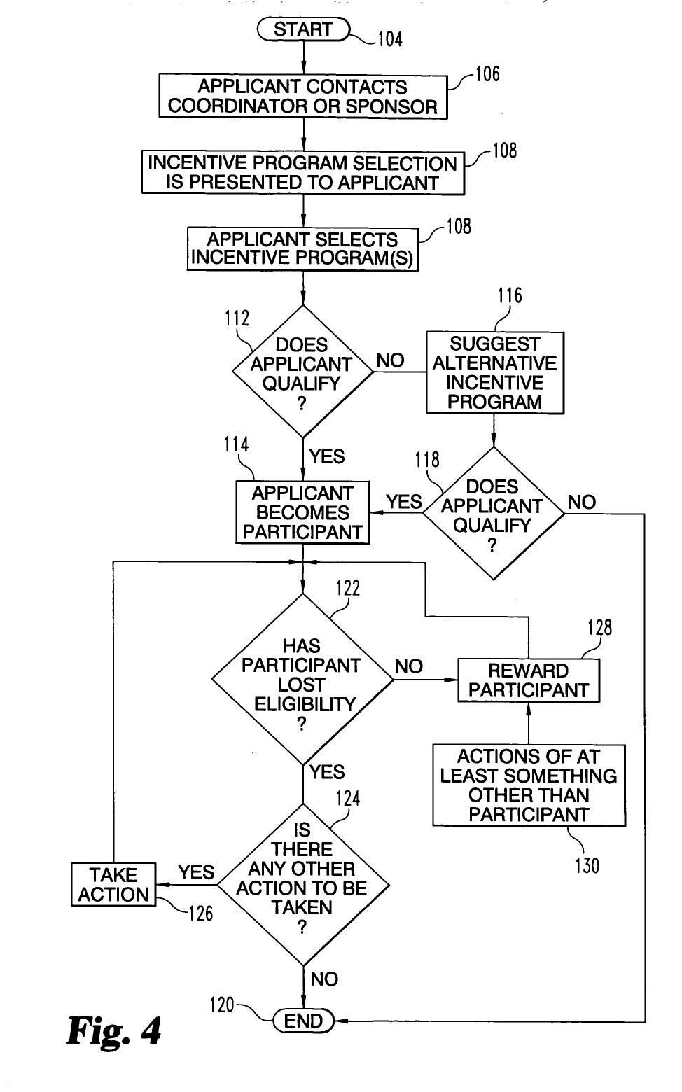

Referring now to FIG. 4, another embodiment of the present invention is illustrated. The method starts at block 104 and then moves to block 106. At block 106, the applicant contacts an incentive program coordinator or sponsor. After the applicant contacts the coordinator or sponsor, the coordinator or sponsor provides an incentive program selection to applicant at block 108. The applicant then selects the incentive program at block 110. The selection can be made electronically, or by filling out paperwork if contacted by mail or any other method readily apparent to those skilled in the art. Then at decision tree 112, it is determined whether or not an applicant qualifies to enter the chosen incentive program. This qualification can be based on a variety of factors, as listed before, such as financial strength, credit information, purchasing decisions and the like. If the applicant does qualify, the applicant becomes a participant as shown in block 114. Alternatively, if the applicant does not qualify for the program they selected, the incentive coordinator or the sponsor can suggest an alternate incentive program that applicant may qualify for as shown in block 116. After an alternative incentive program has been presented, the method again moves to decision block 118 and determines whether or not the applicant qualifies for the alternative incentive program. If the applicant does, the applicant becomes a participant at block 114. If the applicant does not qualify for an alternative incentive program, then the method ends at block 120.

Once the applicant becomes a participant then the method illustrated on blocks 92-102 in FIG. 3 is repeated. First it is determined whether or not the participant has lost eligibility in block 122. If they have, it is then determined if there is any other action to be taken at block 124. If there is not, then the algorithm ends at block 120. If so, then action is taken at block 126 and the algorithm goes back to determining if the participant has loss of eligibility again at block 122. If the participant has not lost eligibility then the participant is rewarded at block 128 based on the actions of at least something other than the participant in block 130.

Referring to block 106, the applicant can contact the coordinator or sponsor through any method apparent to those skilled in the art. For example, in one embodiment the applicant contacts the sponsor at the web site of the sponsor. The applicant may be a sports fan that visits the web site of the sports team and wants to participate in the incentive program sponsored by the sponsor or coordinated by the coordinator. As shown in block 110, in the embodiment illustrated in FIG. 4, a structured level of programs are provided. This can have many beneficial aspects. For example, if the sponsor is a sports team, fans with a higher level of loyalty, who are motivated to purchase more often, can be enrolled in a higher level incentive program. Similarly, fans that are wealthier individuals can be part of a VIP-type incentive program. Therefore, the sponsor may be better able to reward those that are more loyal to them. For instance, if the fan is a season ticket holder, then the fan could be enrolled in an incentive program where fifty incentive points are earned for every touchdown. In contrast, if the fan only attends one or two games a year, then perhaps they could only obtain five points per touchdown. It is readily apparent to those skilled in the art that an infinite amount of permutations could be expanded upon and still stay within the principles of the embodiment illustrated.

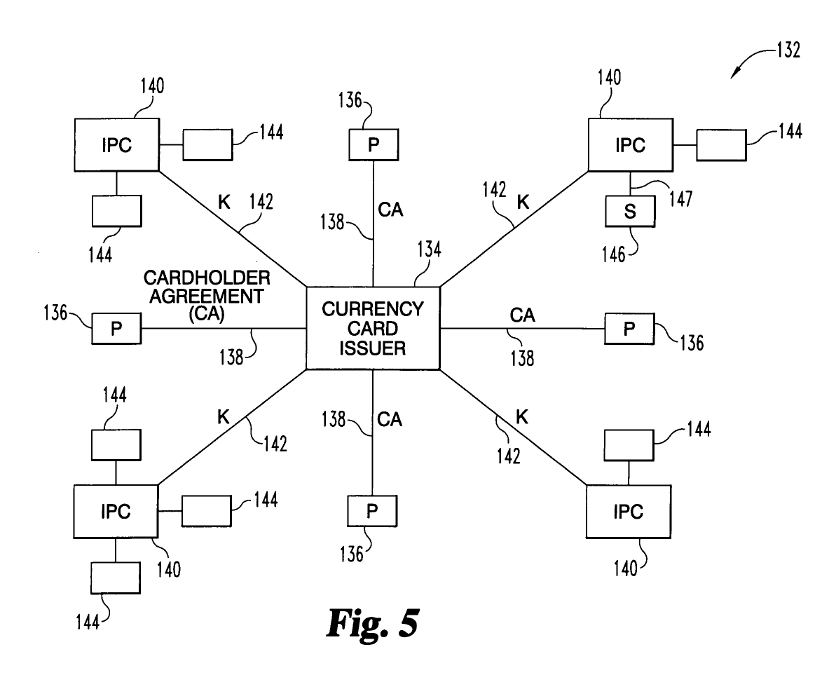

FIG. 5 illustrates a business structure 132 according to one embodiment. A currency card issuer 134 provides currency cards for use by a plurality of participants 136. The pluralities of participants 136 are operatively coupled to the currency card issuer by means of a legally binding contract. Generally, these contracts are known as Cardholder Agreements, shown as 138. The Cardholder Agreements spell out the legal relationship between the currency card issuer 134 and the participants 136. They commonly will describe the terms, interest rate, credit balances and other aspects of the agreement. In addition, the incentive program designated or chosen by the participant will likely also be discussed in the Cardholder Agreement 138.

The currency card issuer 134 is also operatively coupled to the incentive program coordinators (IPC) 140. In the illustrated embodiment, the incentive program coordinators are operatively coupled to the currency card issuer 134 through the use of a legal contract 142. Other embodiments contemplate other business relationships. For example, the incentive program coordinator 140 and the currency card issuer 134 could be the same entity in some embodiments. It is also contemplated that other embodiments can have more or less incentive program coordinators. In one embodiment, only one incentive program coordinator 140 is operatively coupled to currency card issuer 134 through a contract 142. Other embodiments contemplate even more incentive program coordinators 140. The incentive program coordinators 140 administer the incentive programs that reward the participants 136 based on the actions of at least something other than the participant 144. The incentive program coordinators 140 take information about the actions of at least something other than the participant 144. It could be only one something other than participant 144 as shown in the lower right hand corner of FIG. 5. Conversely, there could be a plurality of at least something other than participants 144 whose performance is evaluated to determine the amount of rewards provided to the participant 136. An incentive program coordinator 140 that takes information from a plurality of at least something other than the participant 144 is shown in the lower left-hand corner. For example, one incentive program coordinator can coordinate all the information concerning all the professional football teams in the United States. Other incentive program coordinators could have a contract with just one professional football team to run their officially sponsored incentive program. It should be readily apparent to those skilled in the art that an infinite variety of relationships between at least something other than the participant 144 and the incentive program coordinator 140 can be contemplated. In addition, in the upper right hand corner of FIG. 5, a sponsor (S) 146 is shown operatively coupled to incentive program coordinator 140 through the use of a legally binding contract 147. The sponsor in the illustrated embodiment pays a fee to the incentive program coordinator 140 and the incentive program coordinator 140 reviews information based on a third party 144. The sponsor 146 has an incentive for doing so to promote the third party, or itself, to a large group of participants that are connected to the currency card issuer as cardholders.

In operation, the structure works as follows. The participant 136 enters into a Cardholder Agreement 138 with the currency card issuer 134. The currency card issuer 134 has created a contract called a Cardholder Agreement 138 which sets the amount of interest rate, annual fees and other types of information pertinent to use of the currency card. The participant 136 can be automatically enrolled into the incentive program simply by virtue of entering into the Cardholder Agreement or could separately choose the incentive program that they desire. For example, in the illustrated embodiment, the incentive program coordinators 140 could all each be taking information for a different sport. Therefore, one incentive program coordinator could coordinate basketball, the other could coordinate football, the other could coordinate baseball, and the last could coordinate golf. The participant 136 could have the option of choosing which incentive program they desire based on the sport that they enjoy the most. Alternatively, the currency card issuer 134 could issue applications that automatically make the participant a member of a designated incentive program simply by entering into the Cardholder Agreement 138.

The incentive program coordinator 140 is legally bound to the currency card issuer 134 through a contract. In the illustrated embodiment, the currency card issuer 134 pays the incentive program coordinator 140 a fee in exchange for the incentive program coordinator 140 running the incentive program. The currency card issuer 134 has an incentive to do so in order to create more sales by having more participants 136 want cards issued by the currency card issuer 134 so they can become eligible for the incentive program. In addition, the eligibility requirements for the incentive program may incent the participant 130 to take actions that increase the revenue generated for the currency card issuer 134.

For one example, the participant could be attending a game of their favorite football team and notice that two touchdowns were scored leading to 100 points obtained on their card. It should be appreciated, however, that an incentive program coordinator 130 can modify the earn ratios at any time in different embodiments. The 100 points could be redeemable at the game for free food or drinks. In this hypothetical example, suppose the 100 points earned the participant $5 of credit towards any food or drink purchase at the game. Because the participant knows they have $5 worth of free food, the participant goes up to the counter and orders two pretzels that each cost $3. The participant desires to obtain their rewards, and not waste any, so they order over the amount of their credit. The original price of all the food is $6 minus the $5 credit, so they are spending $1 more than they would without the reward. Plus, they are making the entire purchase with their card, instead of cash or other payment method. This increases the amount of credit card sales. The merchant (i.e. the concession stand) has to pay the currency card issuer 3% on all sales accepted and paid for by credit cards. The currency card issuer 134 receives more fees from various merchants because the participant 136 is encouraged to use their card to obtain the rewards earned for them by the at least something other than the participant 144. Therefore, the currency card issuer 134 has motivation to pay the fees to the incentive program coordinator 140 in order to increase their sales.

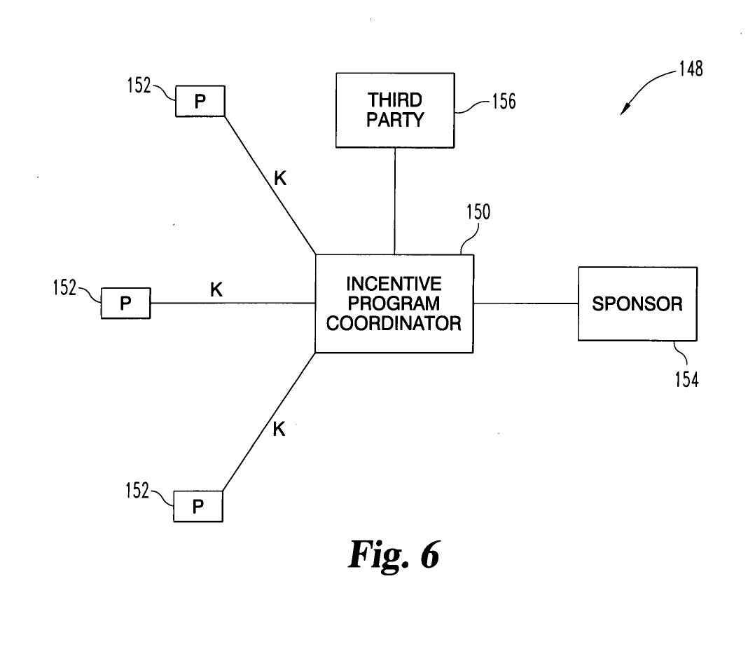

FIG. 6 illustrates an alternative business structure 148. In this embodiment, there is no currency card issuer. The incentive program coordinator 150 is operatively coupled to participants 152 by any known manner, such as a legally binding contract. This coupling could occur various number of ways. For example, the incentive program coordinator 150 may already have contact with the participants 152 as they are employees of an employer who has requested the services of the incentive program coordinator 150 to increase their sales. The sponsor 154 therefore could be the employer themselves or another entity.

For example, the sponsor 154 could be a mutual fund company that desires to sell funds to the employees of a company. The incentive program coordinator 150 already working with that company has an incentive program for its employees 152. Therefore, the incentive program coordinator 150 that is already existing with employee/participants 152 can be contacted by a new sponsor 154 to create an alternate incentive program. The incentive program coordinator 150 can take information about the performance of at least something other than participants and use it as a measure to reward the participants 152. The at least something other than the participants 152 could be a third party 156.

For one example, the third party 156 could be the employer of the participants 152. The mutual funds company 154 can provide additional rewards based upon the performance of the employer 156. To illustrate, the mutual fund company 154 could reduce the amount of fees that it takes for contributions to the fund or it could allow the purchase of additional shares of the fund at a discount to the employees upon an improvement in the employer's performance. Such a structure synergistically provides dual incentives to the employees. The employees would already be participating in the other incentive program operated by incentive program coordinator 150, such as a sales promotion or the like. Thus, when the participants 154 achieve greater sales under the first program they are rewarded once. Plus, the greater sales improve the performance of employer 156 which stimulates the mutual funds company to provide investment products for cheaper to the employees thereby rewarding the employees twice. The mutual funds company then increases the amount of employers that sign onto their program by hiring the incentive program coordinator to operate the program.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for influencing the behavior of a participant in an incentive program comprising:
rewarding said incentive program participant based on the performance of at least something other than said incentive program participant.

2. The method of claim 1, wherein said rewarding is based on the performance of solely something other than said incentive program participant.

3. The method of claim 1, wherein said rewarding is based on a combined performance of something other than said incentive program participant and said incentive program participant.

4. The method of claim 1, wherein said rewarding is based on the performance of a plurality of something other than said incentive program participants.

5. The method of claim 1, wherein said rewarding occurs by providing the participant points redeemable with a currency card.

6. The method of claim 1, wherein said rewarding occurs by providing the participant tickets to an entertainment event.

7. The method of claim 1, wherein said rewarding occurs by providing the participant with currency.

8. The method of claim 1, wherein said rewarding occurs by providing the participant with cash equivalents.

9. The method of claim 1, wherein said rewarding occurs by providing the participant with discounts on purchases.

10. The method of claim 1, wherein said at least something other than said incentive program participant is a sports team.

11. The method of claim 1, wherein said at least something other than said incentive program participant is an athlete.

12. The method of claim 1, wherein said at least something other than said incentive program participant is a country.

13. The method of claim 1, wherein said at least something other than said incentive program participant is a company.

14. The method of claim 1, wherein said at least something other than said incentive program participant is a horse.

15. A method for influencing the behavior of a participant in an incentive program run by a program coordinator comprising:
entering said participant into said incentive program;
operating said incentive program with said program coordinator; and
rewarding said participant based on the performance of at least something other than said incentive program participant.

16. A method for allowing a program coordinator to suggest desired behavior in a participant comprising:
entering said participant into an incentive program; and
rewarding said participant based on the performance of an unrelated third party.

17. A method to provide incentives to consumers comprising:
enrolling said consumer into an incentive program;
providing an incentive program membership identifier to said consumer; and
rewarding said consumer based on the performance of at least something other than said consumer.

18. The method of claim 17, wherein said incentive program membership identifier is a currency card.

19. The method of claim 18, wherein said currency card is a credit card.

20. The method of claim 18, wherein said currency card is a debit card.

21. The method of claim 18, wherein said currency card is a check card.

22. The method of claim 17, wherein said incentive program membership identifier is an account number.

23. The method of claim 17, wherein said incentive program membership identifier is a computer password.

24. The method of claim 17, wherein said incentive program membership identifier is an electronic signature.

25. The method of claim 17, further including the step of determining if said consumer qualifies to enter into said incentive program before enrolling said consumer.

26. The method of claim 25, wherein said determining is performed by evaluating the fiscal strength of said consumer.

27. The method of claim 25, wherein said determining is performed by evaluating the purchasing patterns of said consumer.

28. The method of claim 25, wherein said determining is performed by evaluating demographic information concerning said consumer.

29. The method of claim 17, wherein said rewards are participant specific and can only be accessed using said incentive program membership identifier.

30. The method of claim 17, further including the step of redeeming said rewards by accessing them using said incentive program membership identifier.

31. A method for influencing the behavior of a participant in an incentive program operated by a program coordinator comprising:
requesting qualifying information from a potential participant;
determining if said potential participant qualifies to be a participant in said incentive program;
enrolling said potential participant into said incentive program to become said participant;
rewarding said participant based on the actions of at least something other than said participant;
determining periodically if said participant has maintained eligibility to remain in said incentive program; and
terminating said participants enrollment in said incentive program if eligibility is lost.

32. The method of claim 31 wherein said qualifying information is demographics about said potential participant.

33. The method of claim 31 wherein said qualifying information is information necessary to determine the fiscal strength of said potential participant.

34. The method of claim 31 wherein said qualifying information is information concerning the purchasing decisions of said potential participant.

35. The method of claim 31 wherein said enrolling comprises assigning an account number to said participant.

36. The method of claim 31 wherein said enrolling comprises providing a currency card to said participant.

37. The method of claim 36 wherein said eligibility to remain in said incentive program is lost when said participant fails to use said currency card a predetermined number of times during a predetermined time period.

38. The method of claim 31 wherein said something other than said participant is a sports team.

39. The method of claim 31 wherein said something other than said participant is a country.

40. The method of claim 31 wherein said something other than said participant is a individual.

41. A business structure comprising:
a currency card issuing entity;
an incentive program coordinator entity operatively coupled to said currency card legal entity, wherein said incentive program coordinator calculates and issues rewards;
a participant entity operatively coupled to said currency card issuing legal entity, wherein said coupling results in said participant entity possessing a currency card; and
at least something other than said participant entity, wherein the actions of said at least something other than said participant entity determines the amount of rewards provided by said incentive program coordinator to said currency card issuer that are redeemable by said participant entity.

42. The structure of claim 41, wherein said incentive program coordinator entity is operatively coupled to said currency card issuing entity under a legally binding contract.

43. The structure of claim 41, wherein said participant entity is operatively coupled to said currency card issuing entity under a legally binding contract.

44. The structure of claim 41, wherein said participant entity is a human being.

45. The structure of claim 41, wherein said participant entity is a legally created entity.

46. The structure of claim 41, wherein said participant entity is an organization.

47. The structure of claim 41, wherein said something other than said participant entity is a sports team.

48. The structure of claim 41, wherein said something other than said participant entity is a country.

49. The structure of claim 41, wherein said something other than said participant entity is an individual.

50. The structure of claim 41, wherein said incentive program entity is a legally created entity.

51. The structure of claim 41, wherein said incentive program entity is an individual.

52. The structure of claim 41, wherein said currency card issuing entity is a legally created entity.

53. The structure of claim 41, wherein said rewards are redeemed using said currency card.

54. The structure of claim 41, wherein said currency card is a debit card.

55. The structure of claim 41, wherein said currency card is a credit card.

56. The structure of claim 41, wherein said currency card is a check card.

57. A business structure to operate an incentive program comprising:
a sponsor entity;
an incentive program coordinator entity operatively coupled to said sponsor entity; and
a participant entity operatively coupled to said incentive program coordinator entity in said incentive program determined by said sponsor entity, wherein said incentive program coordinator rewards said participant entity based on the actions of at least something other than said participant entity.

58. The structure of claim 57, wherein said incentive program coordinator entity is operatively coupled to said sponsor entity under a legally binding contract.

59. The structure of claim 57, wherein said participant entity is operatively coupled to said incentive program coordinator entity under a legally binding contract.

60. The structure of claim 57, wherein said participant entity is a human being.

61. The structure of claim 57, wherein said participant entity is a legally created entity.

62. The structure of claim 57, wherein said participant entity is an organization.

63. The structure of claim 57, wherein said something other than said participant entity is a sports team.

64. The structure of claim 57, wherein said something other than said participant entity is a country.

65. The structure of claim 57, wherein said something other than said participant entity is an individual.

66. The structure of claim 57, wherein said incentive program entity is a legally created entity.

67. The structure of claim 57, wherein said incentive program entity is an individual.

68. The structure of claim 57, wherein said sponsor entity is a legally created entity.

69. The structure of claim 57, wherein said rewards are redeemed using said currency card.

70. The structure of claim 57, wherein said currency card is a debit card.

71. The structure of claim 57, wherein said currency card is a credit card.

72. The structure of claim 57, wherein said currency card is a check card.

73. A method to reward consumers based on increased currency card transactions comprising:
providing said currency card to said consumer;
providing said rewards to said consumer based on the performance of at least something other than said consumer; and
requiring said consumer use said currency card a minimum number of times during a predetermined period to obtain said rewards earned by said at least something other than said consumer.

74. The method of claim 73, wherein said at least something other than said consumer is a sports team.

75. The method of claim 73, wherein said at least something other than said consumer is a company.

76. The method of claim 73, wherein said at least something other than said consumer is a country.

77. The method of claim 73, wherein said at least something other than said consumer is an organization.

78. The method of claim 73, wherein said at least something other than said consumer is an individual.

79. The method of claim 73, wherein said currency card is a credit card.

80. The method of claim 73, wherein said currency card is a debit card.

81. The method of claim 73, wherein said currency card is a check card.

82. The method of claim 73, wherein said predetermined period is a calendar year.

83. The method of claim 73, wherein said predetermined period is a calendar month.

84. The method of claim 73, wherein said predetermined period is 30 days.

85. The method of claim 73, wherein said minimum number of times is at least once every five days over the predetermined period.

86. A method for influencing the behavior of a participant in an incentive program operated by a program coordinator comprising:
enrolling a participant into an incentive program;
requiring said participant to satisfy criteria to qualify to receive rewards;
rewarding said participant based on the actions of at least something other than the participant after said participant satisfies said criteria.

87. The method of claim 86, further comprising the step of providing the participant the opportunity to select different aspects of the incentive program.

88. The method of claim 86, wherein at least something other than the participant is a sports team.

89. The method of claim 86, wherein at least something other than the participant is an athlete.

90. The method of claim 86, wherein said criteria requires eating a predetermined number of times from a selected group of restaurants.

91. The method of claim 86, wherein enrolling said participant occurs by issuing a currency card to said participant.

92. The method of claim 91, wherein said criteria requires using a currency card a predetermined number of times over a predetermined time period.
